(19) United States
(12) Patent Application Publication
(10) Pub. No.: US 2005/0078061 A1
(43) Pub. Date: Apr. 14, 2005

(54) Plasma display panel driving method and plasma display

(76) Inventors: Jin-Sung Kim, Suwon-si (KR); Woo-Joon Chung, Suwon-si (KR); Seung-Hun Chae, Suwon-si (KR); Kyoung-Ho Kang, Suwon-si (KR)

Correspondence Address: CHRISTIE, PARKER & HALE, LLP, PO BOX 7068, PASADENA, CA, 91109-7068, US

(21) Appl. No.: 10/947,106

(22) Filed: Sep. 21, 2004

(30) Foreign Application Priority Data
Sep. 22, 2003 (KR) 2003-0065549

(51) Int. Cl. G09G 3/28

(52) U.S. Cl. 345/63

(57) ABSTRACT

In a plasma display panel driving method, a final voltage of a falling ramp voltage is reduced to a voltage for firing a discharge at all the discharge cells in a reset period. A difference between a voltage at an address electrode of a discharge cell to be selected and a voltage applied to a scan electrode is established to be greater than a maximum discharge firing voltage in an address period. A voltage greater than a sustain voltage is applied to the scan electrode so as to convert positive wall charges which can be formed on the scan electrode of a discharge cell which is not selected in the address period into negative wall charges.

### CROSS REFERENCE TO RELATED APPLICATION

This application claims priority to and the benefit of Korea Patent Application No. 2003-65549 filed on Sep. 22, 2003 in the Korean Intellectual Property Office, the content of which is incorporated herein by reference.

### BACKGROUND OF THE INVENTION

(a) Field of the Invention

The present invention relates to plasma display panels (PDPs), and, more particularly, to a driving method therefor.

(b) Description of the Related Art

A PDP is a flat display for showing characters or images using plasma generated by gas discharge. PDPs can include pixels numbering more than several million in a matrix format, in which the number of pixels are determined by the size of the PDP. Referring to FIGS. 1 and 2, a PDP structure will now be described.

FIG. 1 shows a partial perspective view of the PDP, and FIG. 2 schematically shows an electrode arrangement of the PDP.

As shown in FIG. 1, the PDP includes glass substrates 1, 6 facing each other with a predetermined gap therebetween. Scan electrodes 4 and sustain electrodes 5 in pairs are formed in parallel on glass substrate 1. Scan electrodes 4 and sustain electrodes are covered with dielectric layer 2 and protection film 3. A plurality of address electrodes 8 is formed on glass substrate 6, and address electrodes 8 are covered with insulator layer 7. Barrier ribs 9 are formed on insulator layer 7 between address electrodes 8, and phosphors 10 are formed on the surface of insulator layer 7 and between barrier ribs 9. Glass substrates 1, 6 are provided facing each other with discharge spaces between glass substrates 1, 6 so that scan electrodes 4 and sustain electrodes 5 can cross address electrodes 8. Discharge space 11 between address electrode 8 and a crossing part of a pair of scan electrodes 4 and sustain electrodes 5 forms discharge cell 12, which is schematically indicated.

As shown in FIG. 2, the electrodes of the PDP have an n×m matrix format. Address electrodes A₁ to Aₘ are arranged in a column direction, and n scan electrodes Y₁ to Yₙ and n sustain electrodes X₁ to Xₙ are arranged in a row direction. Scan/sustain driving circuit 13 drives the scan and sustain electrodes, while address driving circuit 15 drives the address electrodes.

U.S. Pat. No. 6,294,875 by Kurata for driving a PDP discloses a method for dividing one field into eight subfields and applying different waveforms in the reset period of the first subfield and the second to eighth subfields.

As shown in FIG. 3, a subfield includes a reset period, an address period, and a sustain period. A ramp waveform which gradually rises from voltage Vₚ of less than a discharge firing voltage to voltage Vᵣ that is greater than the discharge firing voltage is applied to scan electrodes Y₁ to Yₙ during the reset period of the first subfield. Weak discharges are generated to address electrodes A₁ to Aₘ and sustain electrodes X₁ to Xₙ from scan electrodes Y₁ to Yₙ while the ramp waveform rises. Negative wall charges are accumulated to scan electrodes Y₁ to Yₙ, and positive wall charges are accumulated to address electrodes A1 to Am and sustain electrodes X₁ to Xₙ because of the discharges. The wall charges are actually formed on protection film 3 on scan electrodes 4 and sustain electrodes 5 in FIG. 1, but the wall charges are described as being generated on scan electrodes 4 and sustain electrodes 5 below for ease of description.

A ramp voltage which gradually falls from voltage V_{q} of less than the discharge firing voltage to voltage 0V (volts) is applied to scan electrodes Y₁ to Yₙ. A weak discharge is generated on scan electrodes Y₁ to Yₙ from sustain electrodes X₁ to Xₙ and address electrodes A₁ to Aₘ by a wall voltage formed at the discharge cells while the ramp voltage falls. Part of the wall charges formed on sustain electrodes X₁ to Xₙ, scan electrodes Y₁ to Yₙ, and address electrodes A₁ to Aₘ are erased by the discharge, and they are established to be appropriate for addressing. In a like manner, the wall charges are actually formed on the surface of insulator layer 7 of address electrode 8 in FIG. 1, but they are described as being formed on address electrode 8 for ease of description.

Next, when positive voltage V_{w} is applied to address electrodes A₁ to Aₘ of the discharge cells to be selected, and 0V is applied to scan electrodes Y₁ to Yₙ in the address period, addressing is generated between address electrodes A₁ to Aₘ and scan electrodes Y₁ to Yₙ, and between sustain electrodes X₁ to Xₙ and scan electrodes Y₁ to Yₙ by the wall voltage caused by the wall charges formed during the reset period and positive voltage V_{w}. By the addressing, positive wall charges are accumulated on scan electrodes Y₁ to Yₙ, and negative wall charges are accumulated on sustain electrodes X₁ to Xₙ and address electrodes A₁ to Aₘ. Sustaining is generated on the discharge cells on which the wall charges are accumulated by the addressing, by a sustain pulse applied during the sustain period.

A voltage level of the last sustain pulse applied to scan electrodes Y₁ to Yₙ during the sustain period of the first subfield corresponds to voltage Vᵣ of the reset period, and voltage (Vᵣ-Vₛ) corresponding to a difference between voltage Vᵣ and sustain voltage Vₛ is applied to sustain electrodes X₁ to Xₙ. A discharge is generated from scan electrodes Y₁ to Yₙ to address electrodes A₁ to Aₘ because of the wall voltage formed by the addressing, and sustaining is generated from scan electrodes Y₁ to Yₙ to sustain electrodes X₁ to Xₙ in the discharge cells selected in the address period. The discharges correspond to the discharges generated by the rising ramp voltage in the reset period of the first subfield. No discharge occurs in the discharge cells which are not selected since no addressing is provided in the discharge cells.

In the reset period of the second following subfield, voltage Vₕ is applied to sustain electrodes X₁ to Xₙ, and a ramp voltage which gradually falls from voltage V_{q} to 0V is applied to scan electrodes Y₁ to Yₙ. That is, the voltage which corresponds to the falling ramp voltage applied during the reset period of the first subfield is applied to scan electrodes Y₁ to Yₙ. A weak discharge is generated on the discharge cells selected in the first subfield, and no discharge is generated on the discharge cells that are not selected.

In the reset period of the last following subfield, the same waveform as that of the reset period of the second subfield is applied. An erase period is formed after the sustain period in the eighth subfield. A ramp voltage which gradually rises from 0V to voltage Vₑ is applied to sustain electrodes X₁ to Xₙ during the erase period. The wall charges formed in the discharge cells are erased by the ramp voltage.

As to the above-described conventional driving waveforms, discharges are generated on all the discharge cells by the rising ramp voltage in the reset period of the first subfield, and accordingly, the discharges problematically occur in the cells which are not to be displayed, thereby worsening the contrast ratio. Further, since the addressing is sequentially performed on all scan electrodes in the address period of using an internal wall voltage, the internal wall voltage of scan electrodes that are selected in the later stage is lost. The lost wall voltage reduces margins as a result.

### SUMMARY OF THE INVENTION

In accordance with the present invention a PDP driving method is provided for performing addressing without using an internal wall voltage. A PDP driving method is also provided for applying part of pulses as those having a voltage greater than a sustain voltage during a sustain period to solve the problem of cells which are not reset in a reset period.

In one aspect of the present invention, a method is provided for driving a PDP having a plurality of first electrodes and second electrodes respectively formed in parallel on a first substrate, and a plurality of third electrodes which cross the first and second electrodes and are formed on a second substrate. A discharge cell is formed by the adjacent first, second, and third electrodes. A field is divided into a plurality of subfields and then driven. Each subfield includes a reset period, an address period, and a sustain period, and all the subfields respectively configure at least one field. A ramp voltage which gradually falls from a first voltage to a second voltage is applied to the first electrode, during the reset period. A third voltage and a fourth voltage are respectively applied to the first electrode and the third electrode of a discharge cell to be selected from among the discharge cells, during the address period. A fifth voltage is alternately applied to the first and second electrodes, and a sixth voltage which has a gradually rising interval is applied to the first electrode in at least one of intervals for applying the fifth voltage to the second electrode after applying the fifth electrode to the first electrode, during the sustain period.

In another aspect of the present invention, a method is provided for driving a PDP having a plurality of first electrodes and second electrodes respectively formed in parallel on a first substrate, and a plurality of third electrodes which cross the first and second electrodes and are formed on a second substrate. A discharge cell is formed by the adjacent first, second, and third electrodes. A field is divided into a plurality of subfields and then driven, each subfield including a reset period, an address period, and a sustain period, and all the subfields respectively configuring at least one field. A ramp voltage which gradually falls from a first voltage to a second voltage is applied to the first electrode, during the reset period. A third voltage and a fourth voltage are respectively applied to the first electrode and the third electrode of a discharge cell to be selected from among the discharge cells, during the address period. A fifth voltage is alternately applied to the first and second electrodes, and at least one sixth voltage which rises from the fifth voltage is applied instantly after applying the fifth electrode to the first electrode, during the sustain period. The sixth voltage is greater than the fifth voltage.

In still another aspect of the present invention, a method is provided for driving a PDP having a plurality of first electrodes and second electrodes respectively formed in parallel on a first substrate, and a plurality of third electrodes which cross the first and second electrodes and are formed on a second substrate. A discharge cell is formed by the adjacent first, second, and third electrodes. During the sustain period, a first voltage is alternately applied to the first and second electrodes, and a second voltage which gradually rises is applied to the first electrode in at least one of intervals for applying the first voltage to the second electrode after applying the first voltage to the first electrode. The positive wall charges provided on the first electrode of the cell which is not selected in the address period for selecting a cell to be selected are converted into negative wall charges by applying the second voltage.

In further another aspect of the present invention, a method is provided for driving a PDP having a plurality of first electrodes and second electrodes respectively formed in parallel on a first substrate, and a plurality of third electrodes which cross the first and second electrodes and are formed on a second substrate. A discharge cell is formed by the adjacent first, second, and third electrodes. During the sustain period, a first voltage is alternately applied to the first and second electrodes, and at least one second voltage which rises from the first voltage is applied instantly after applying the first voltage to the first electrode. The positive wall charges provided on the first electrode of the cell which is not selected in the address period for selecting a cell to be selected are converted into negative wall charges by applying the second voltage.

In still further another aspect of the present invention, a plasma display includes: a first substrate; a plurality of first electrodes and second electrodes facing the first substrate with a gap; a second substrate; a plurality of third electrodes crossing the first and second electrodes and being formed on the second substrate; and a driving circuit for applying a driving voltage to the first, second, and third electrodes so as to discharge a discharge cell formed by the adjacent first, second, and third electrodes. The driving circuit alternately applies a first voltage to the first and second electrodes, and applies a second voltage in at least one of intervals for applying the first voltage to the second electrode after applying the first voltage to the first electrode during a sustain period. The second voltage is greater than the first voltage to convert positive wall charges provided on the first electrode of a cell which is not selected in an address period for selecting a cell to be discharged into negative wall charges.

### BRIEF DESCRIPTION OF THE DRAWINGS

FIG. 1 shows a simplified perspective view of a general PDP.

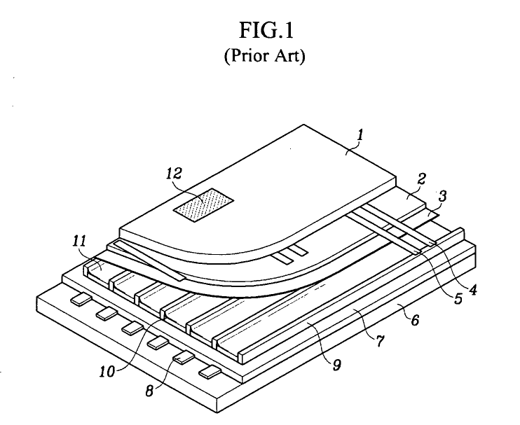

FIG. 2 shows an electrode arrangement diagram of a general PDP.

FIG. 3 shows a conventional PDP driving waveform diagram.

FIG. 4 shows a PDP driving waveform diagram according to a first exemplary embodiment of the present invention.

FIG. 5 shows a PDP driving waveform diagram according to a second exemplary embodiment of the present invention.

FIG. 6 shows a PDP driving waveform diagram according to a third exemplary embodiment of the present invention.

FIG. 7 shows a PDP driving waveform diagram according to a fourth exemplary embodiment of the present invention.

FIG. 8 shows a PDP driving waveform diagram according to a fifth exemplary embodiment of the present invention.

FIG. 9 shows a PDP driving waveform diagram according to a sixth exemplary embodiment of the present invention.

### DETAILED DESCRIPTION

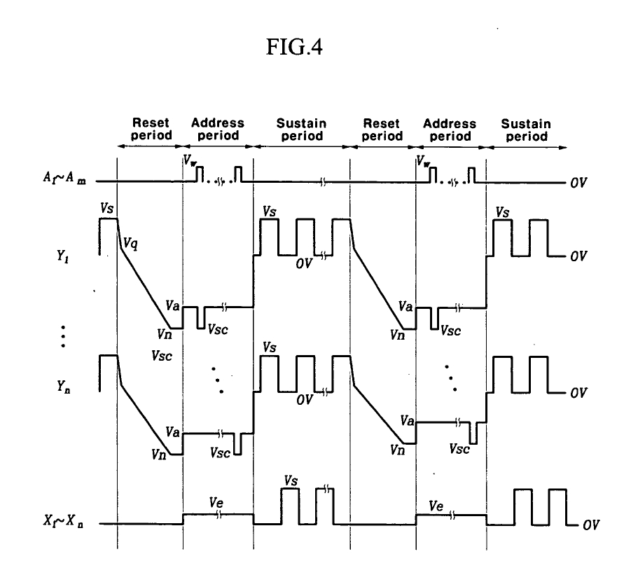

Referring to FIG. 4, a PDP driving method according to a first exemplary embodiment of the present invention will be described. Notations of reference numerals as address electrodes A₁ to Aₘ, scan electrodes Y₁ to Yₙ, and sustain electrodes X₁ to Xₙ represent that the same voltage is applied to address electrodes, scan electrodes, and sustain electrodes, and notations of reference numerals as address electrodes Aᵢ and scan electrodes Yⱼ represent that a corresponding voltage is applied to some of address electrodes and scan electrodes.

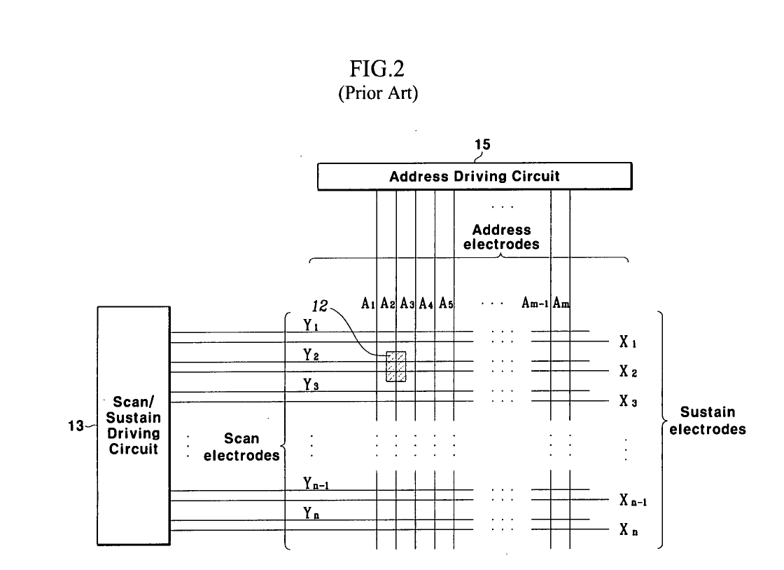

FIG. 4 shows a PDP driving waveform diagram according to a first exemplary embodiment of the present invention. As shown, the driving waveform according to the first exemplary embodiment includes a reset period, an address period, and a sustain period. As shown in FIG. 2, the PDP is coupled to scan/sustain driving circuit 13 for applying a driving voltage to scan electrodes Y₁ to Yₙ and sustain electrodes X₁ to Xₙ and an address driving circuit 15 for applying a driving voltage to address electrodes A₁ to Aₘ in each period in accordance with the present invention. The driving circuits and the PDP coupled thereto configure a plasma display.

The wall charges formed in the sustain period are eliminated in the reset period. Discharge cells to be displayed are selected from among the discharge cells in the address period. The discharge cells selected in the address period are discharged in the sustain period.

In the sustain period, sustaining is performed by a difference between the wall voltage caused by the wall charges formed in the discharge cells selected in the address period and the voltage formed by the sustain pulse applied to the scan electrode and the sustain electrode. Voltage Vₛ is applied to scan electrodes Y₁ to Yₙ at the last sustain pulse in the sustain period, and a reference voltage (assumed as 0V in FIG. 4) is applied to sustain electrodes X₁ to Xₙ. The selected discharge cell is discharged between scan electrode Yⱼ and sustain electrode Xⱼ, and negative and positive wall charges are respectively formed on scan electrode Yⱼ and sustain electrode Xⱼ.

In the reset period, a ramp voltage which gradually falls from voltage V_{q} to voltage Vₙ is applied to scan electrodes Y₁ to Yₙ after the last sustain pulse is applied in the sustain period, and reference voltage 0V is applied to address electrodes A₁ to Aₘ and sustain electrode Xⱼ.

In general, when the voltage between scan electrode Y and address electrode A or between scan electrode Y and sustain electrode X is greater than the discharge firing voltage, a discharge occurs between scan electrode Y and address electrode A or between scan electrode Y and sustain electrode X, and the discharge firing voltage is varied according to states of the discharge cells. Therefore, in the first exemplary embodiment, voltage Vn has a value for allowing all the discharge cells to be discharged from address electrodes A₁ to Aₘ to scan electrodes Y₁ to Yₙ. All the discharge cells include discharge cells which are provided at an area that can influence displaying a screen on the PDP.

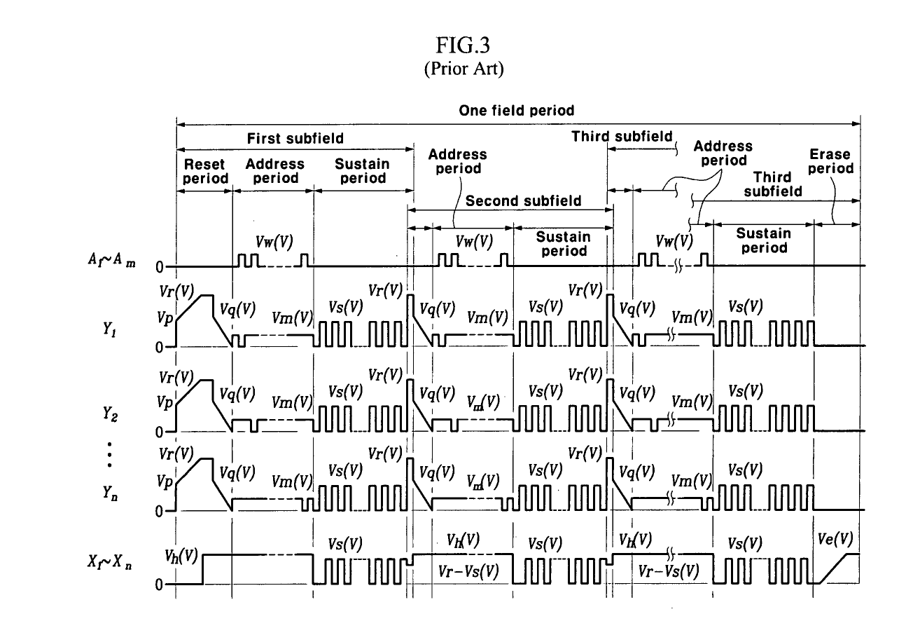

As given in Equation 1, the difference V_{A-Y,reset} between voltage 0V applied to address electrodes A₁ to Aₘ and voltage Vₙ applied to scan electrodes Y₁ to Yₙ is established to be greater than a maximum discharge firing voltage V_{f,MAX} from among the discharge firing voltages. In this instance, it is desirable for the size |Vₙ| of voltage Vₙ to be less than voltage Vᵣ since wall charges can be formed when voltage V_{A-Y,reset} is very big in the same manner of voltage Vr of the driving waveform of FIG. 3.

Equation 1
V_{A-Y,reset}=|Vₙ≧V_{f,MAX}

Hence, a weak discharge is generated between sustain electrodes X₁ to Xₙ and scan electrodes Y₁ to Yₙ and between address electrodes A₁ to Aₘ and scan electrodes Y₁ to Yₙ because of the falling ramp voltage. In the case of the discharge cell selected in the previous subfield, the wall charges are erased by the weak discharge since the wall charges are formed on scan electrode Yⱼ, sustain electrode Xⱼ, and address electrode Aⱼ. In this instance, since a large amount of wall charges are not formed in the discharge cell, most of the wall charges formed in the discharge cell are erased, and only a predetermined amount of wall charges which can delete the non-uniformity between the discharge cells remain. In the case of discharge cells which are not selected in the previous subfield, the wall charges which can only solve the non-uniformity between the discharge cells are formed by the weak discharge caused by the falling ramp voltage, or the wall charges are rarely formed.

Accordingly, most of the wall charges of all the discharge cells are erased when passing through the reset period according to the first exemplary embodiment of the present invention.

In the address period, the voltages at scan electrodes Y₁ to Yₙ and sustain electrodes X₁ to Xₙ are maintained at Vₐ and Vₑ respectively, and voltages are applied to scan electrodes Y₁ to Yₙ and address electrodes A₁ to Aₘ so as to select discharge cells to be displayed. That is, negative voltage V_{sc} is applied to scan electrode Y₁ of the first row, and positive voltage V_{w} is applied to address electrode A₁ which is concurrently provided on the discharge cell to be displayed in the first row. Voltage V_{sc} corresponds to voltage Vₙ in FIG. 4.

Accordingly, as given in Equation 2, the voltage difference V_{A-Y,address} between address electrode Aᵢ and scan electrode Y₁ in the discharge cell selected in the address period always becomes greater than the maximum discharge firing voltage V_{f,MAX}, and the voltage difference between sustain electrode X₁ to which voltage Vₑ is applied and scan electrode Y₁ becomes greater than the maximum discharge firing voltage V_{f,MAX}.

Equation 2
V_{A-Y,address}=V_{A-Y,reset}+V_{w}≧V_{f,MAX}

Therefore, addressing is generated between address electrode Aᵢ and scan electrode Y₁ and between sustain electrode X₁ and scan electrode Y₁ in the discharge cell formed by address electrode Aᵢ to which voltage V_{w} is applied and scan electrode Y₁ to which voltage V_{sc} is applied. As a result, positive wall charges are formed on scan electrode Y₁ and negative wall charges are formed on sustain electrode X₁ and address electrode Aᵢ.

Next, voltage V_{sc} is applied to scan electrode Y₂ in the second row, and voltage V_{w} is applied to address electrode Aᵢ provided on the discharge cell to be displayed in the second row. As a result, addressing is generated in the discharge cell formed by address electrode Aᵢ to which voltage V_{w} is applied and scan electrode Y₁ to which voltage V_{sc} is applied, and hence, the wall charges are formed in the discharge cell. In a like manner, voltage V_{sc} is sequentially applied to scan electrodes Y₃ to Yₙ in the residual rows, and voltage V_{w} is applied to address electrodes provided on the discharge cells to be displayed, thereby forming the wall charges.

In the sustain period, voltage Vₛ is applied to scan electrodes Y₁ to Yₙ and reference voltage 0V is applied to sustain electrodes X₁ to Xₙ. The voltage between scan electrode Yⱼ and sustain electrode Xⱼ exceeds the discharge firing voltage in the discharge cell selected in the address period since the wall voltage caused by the positive wall charges of scan electrode Yⱼ and the negative wall charges of sustain electrode Xⱼ formed in the address period is added to voltage Vₛ. Therefore, sustaining is generated between scan electrode Yⱼ and sustain electrode Xⱼ. Negative and positive wall charges are respectively formed on scan electrode Yⱼ and sustain electrode Xⱼ of the discharge cell on which the sustaining is generated.

Next, 0V is applied to scan electrodes Y₁ to Yₙ and voltage Vₛ is applied to sustain electrodes X₁ to Xₙ. In the previous discharge cell in which the sustaining is generated, the voltage between sustain electrode Xⱼ and scan electrode Yⱼ exceeds the discharge firing voltage since the wall voltage caused by the positive wall charges of sustain electrode Xⱼ and the negative wall charges of scan electrode Yⱼ formed in the previous sustaining is added to voltage Vₛ. Therefore, the sustaining is generated between scan electrode Yⱼ and sustain electrode Xⱼ, and the positive and negative wall charges are respectively formed on scan electrode Yⱼ and sustain electrode Xⱼ of the discharge cell in which the sustaining is generated.

In a like manner, a voltages Vs and 0V are alternately applied to scan electrodes Y₁ to Yₙ and sustain electrodes X₁ to Xₙ to maintain the sustaining. As described, the last sustaining is generated while voltage Vs is applied to scan electrodes Y₁ to Yₙ and 0V is applied to sustain electrodes X₁ to Xₙ. A subfield which starts from the above-noted reset period is provided after the last sustaining.

In the first exemplary embodiment, the addressing is generated when no wall charges are formed in the reset period, by allowing the voltage difference between the address electrode and the scan electrode of the discharge cell to be displayed in the address period to be greater than the maximum discharge firing voltage. Hence, the problem of worsening the margins is removed since the addressing is not influenced by the wall charges formed in the reset period. The amount of discharging is reduced in the reset period compared to the prior art since no wall charges are used in the addressing, and there is no need of forming the wall charges by using the rising ramp voltage in the reset period in the same manner of the prior art. Therefore, the contrast ratio is improved since the amount of discharges by the reset period is reduced in the discharge cells which do not emit light. Further, the maximum voltage applied to the PDP is lowered since the voltage Vᵣ is eliminated of FIG. 3.

The circuit for driving scan electrodes is simplified since voltages V_{sc}, Vₙ can be supplied by the same power source by making voltages V_{sc}, Vₙ correspond to each other. In addition, the addressing is generated irrespective of the wall charges since the voltage difference between the address electrode and the scan electrode in the selected discharge cell can be greater than the maximum discharge firing voltage by greater than voltage V_{w}.

In the first exemplary embodiment, the reference voltage is established to be 0V, and it can further be set to be other voltages. When it is possible to allow the difference between voltages V_{w} and V_{sc} to be greater than the maximum discharge firing voltage, voltage V_{sc} can be different from voltage Vₙ.

In FIG. 4, voltage Vₑ applied to sustain electrodes X₁ to Xₙ in the address period is set to be a positive voltage. Voltage Vₑ can be varied if a discharge can be generated between scan electrode Yⱼ and sustain electrode Xⱼ by the discharge between scan electrode Yⱼ and address electrode Aᵢ in the address period. That is, voltage Vₑ can be 0V or a negative voltage.

A PDP driving method for solving a problem which may occur in the first exemplary embodiment of the present invention will now be described.

In the PDP driving waveform as shown in FIG. 4, positive wall charges can be formed on scan electrodes Y₁ to Yₙ since a ramp waveform falling to negative voltage Vₙ is applied in the reset period. Further positive wall charges can be formed when negative voltage V_{sc} is sequentially applied to scan electrodes Y₁ to Yₙ in the address period in the cell wherein the positive wall charges are accumulated on scan electrodes Y₁ to Yₙ. Also, the positive wall charges are maintained when a ramp voltage waveform falling in the reset period is applied in the case that the cell wherein the positive wall charges are accumulated on scan electrodes Y₁ to Yₙ is not selected in the address period. Since the small amount of positive wall charges provided on scan electrodes Y₁ to Yₙ are not reset during resetting in the reset period, addressing in the next subfield may not be well executed.

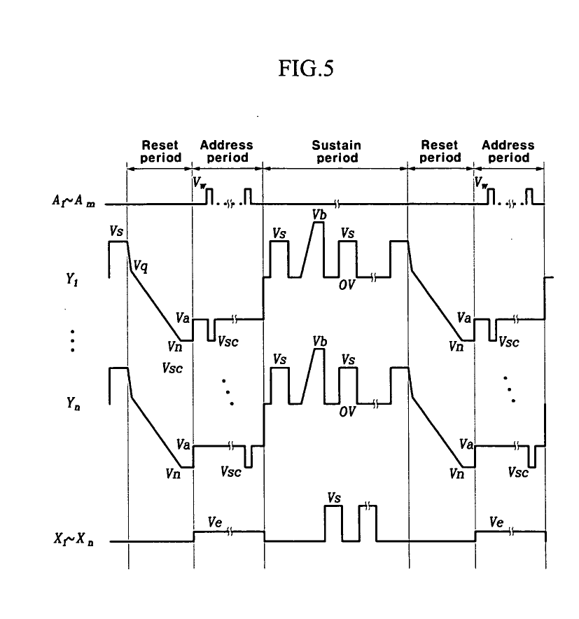

FIGS. 5 to 8 show PDP driving waveform diagrams for erasing the positive wall charges which can be formed on scan electrodes Y₁ to Yₙ in the case of the waveform of FIG. 4.

FIG. 5 shows a PDP driving waveform diagram according to a second exemplary embodiment of the present invention. As shown, the driving waveform according to the second exemplary embodiment of the present invention correspond to those of FIG. 4, and a predetermined ramp waveform is further applied to scan electrodes Y₁ to Yₙ in the sustain period of FIG. 4. That is, when voltage Vs is alternately applied between scan electrodes Y₁ to Yₙ and sustain electrodes X₁ to Xₙ in the sustain period to perform sustaining, a ramp waveform of FIG. 5 is applied to scan electrodes Y₁ to Yₙ between the first period of applying voltage Vₛ to scan electrodes Y₁ to Yₙ and the second period of applying voltage Vₛ to sustain electrode after the first period. The ramp waveform influences no cells selected during the address period (no discharge is generated when the positive voltage is applied since the negative wall charges are accumulated on the scan electrode by application of the sustain voltage Vₛ) since the ramp waveform is applied again to scan electrodes Y₁ to Yₙ after sustain voltage Vₛ is applied to scan electrodes Y₁ to Yₙ, and since a weak discharge is generated on the cell which is not selected during the address period and in which the positive wall charges are accumulated on the scan electrode as described above (since the positive wall charges are formed on the scan electrode, a discharge occurs when a positive voltage is applied to the scan electrode), a small amount of negative wall charges are accumulated on the scan electrode of the cell which is not selected during the address period, and a reset operation is performed when a falling ramp is applied in the reset period. Accordingly, no malfunction is generated in the addressing of the next subfield. In this instance, the ramp waveform is a voltage which rises to predetermined voltage V_{b} which is greater than the sustain voltage Vₛ so as to generate a weak discharge. That is, sustain voltage Vₛ applies an appropriate voltage to the scan electrode so that the weak discharge may occur in the discharge cell with formed positive wall charges. The ramp waveform is applied immediately after the sustain voltage is applied to the scan electrode in FIG. 5, but the ramp waveform can be applied to scan electrodes Y₁, Yₙ in any interval of sustain voltages Vₛ alternately applied to the scan electrode and the sustain electrode. Also, the ramp waveform can be applied at least once in the sustain period.

FIG. 5 illustrates applying the ramp waveform. However, a resistor-capacitor (RC) resonance waveform, a floating waveform, and a step form waveform which gradually rise can also be applied in addition to the ramp waveform to thus obtain the same effect as that of FIG. 5.

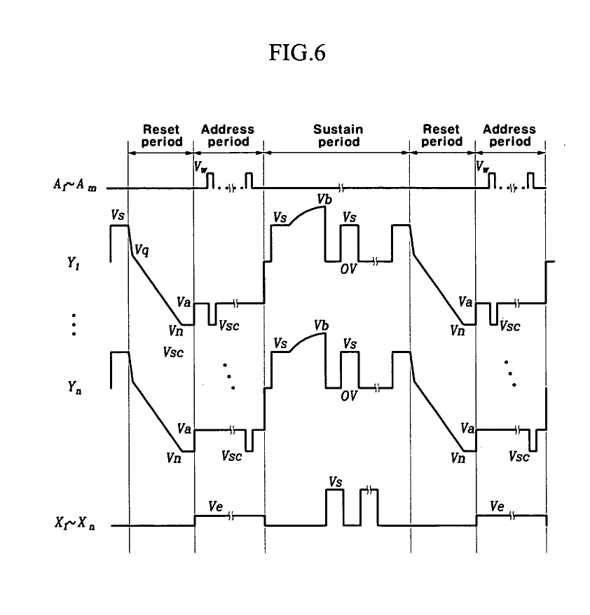

FIG. 6 shows a PDP driving waveform diagram according to a third exemplary embodiment of the present invention. As shown, differing from FIG. 5, sustain voltage Vₛ is applied to scan electrodes Y₁ and Yₙ and an RC resonance waveform which rises to voltage V_{b} is applied thereto in the sustain period. In this instance, in the period of applying sustain voltage Vₛ to scan electrodes Y₁ to Yₙ, sustaining is generated in the cell which is selected in the address period and no sustaining is generated in the cell which is not selected in the address period, and a weak discharge is generated in the cell which is not selected in the address period and in which the positive wall charges are accumulated on the scan electrode when the RC resonance waveform is applied. In this instance, voltage V_{b} applies an appropriate voltage to the scan electrode so that a weak discharge may be generated in the discharge cell with the formed positive wall charges. Hence, the negative wall charges are accumulated on the scan electrode which is not selected in the address period, the scan electrode is reset by a ramp waveform of the next reset period, and no malfunction is generated when the scan electrode is selected in the next address period. Also, the cell which is selected in the address period when applying the RC resonance waveform is not influenced by the RC resonance waveform since the RC resonance waveform is applied after the sustaining. The waveform for applying sustain voltage Vs and instantly applying the RC resonance waveform can be applied to scan electrodes Y₁ to Yₙ anytime during the sustain period, at least once.

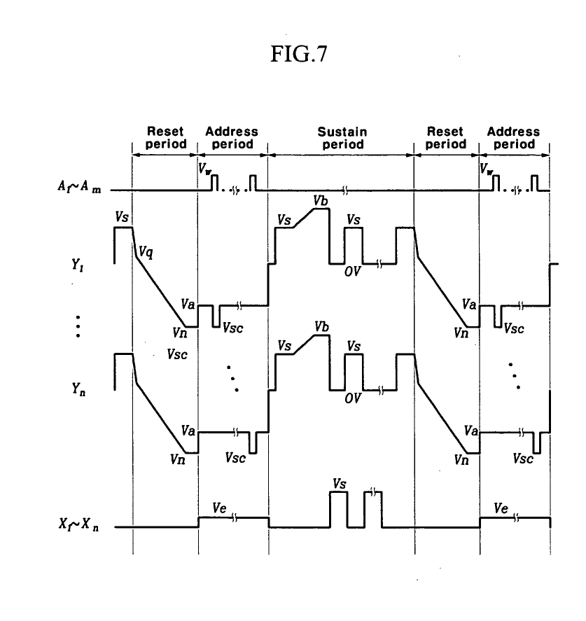

FIG. 7 shows a PDP driving waveform diagram according to a fourth exemplary embodiment of the present invention. As shown, the fourth exemplary embodiment corresponds to the third exemplary embodiment of FIG. 6 except that a ramp waveform rising to voltage V_{b} is applied after sustain voltage Vₛ is applied to scan electrodes Y₁, Yₙ. By applying the above-noted ramp waveform, the negative wall charges are accumulated on the scan electrode of the cell which is not selected during the address period and in which the positive wall charges are accumulated. Through this process, resetting is performed by a ramp waveform of the next reset period, and the scan electrode is addressed when selected in the next address period. Further, the cell which is selected in the address period is not influenced by the ramp waveform since the ramp waveform is applied after the sustaining at the time of applying the ramp waveform. The ramp waveform of FIG. 7 can be applicable to scan electrodes Y₁, Yₙ at least once at any time of the sustain period.

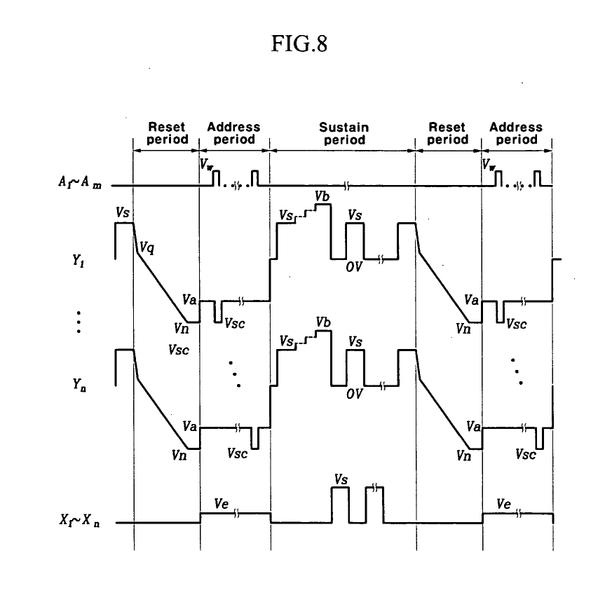

FIG. 8 shows a PDP driving waveform diagram according to a fifth exemplary embodiment of the present invention. As shown, the fifth exemplary embodiment corresponds to the third exemplary embodiment of FIG. 6 except that a floating waveform is applied after sustain voltage Vₛ is applied to scan electrodes Y₁, Yₙ. By applying the floating waveform after varying the constant voltage, the negative wall charges are accumulated on the scan electrode of the cell which is not selected in the address period and in which the positive wall charges are accumulated on the scan electrode. Through this process, resetting is performed by the ramp waveform of the next reset period, and the scan electrode is addressed when selected during the next address period. Also, the cell which is selected in the address period is not influenced by the floating waveform at the time of applying the floating waveform since the floating waveform is applied after the sustaining. The floating waveform of FIG. 7 can be applied to scan electrodes Y₁ to Yₙ at any time of the sustain period, at least once.

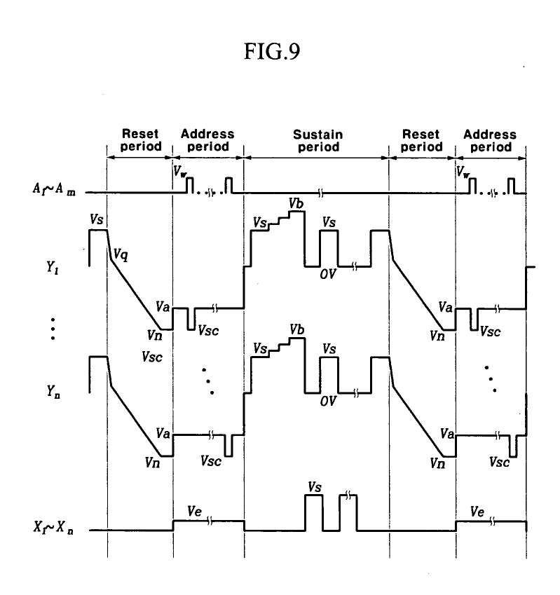

FIG. 9 shows a PDP driving waveform diagram according to a sixth exemplary embodiment of the present invention where a staircase waveform for applying and maintaining a constant voltage is applied, from which the same effects are obtained.

The applied ramp waveform, the RC resonance waveform, the floating waveform, and the staircase waveform of FIGS. 5 to 9 are generated by configuration of simple circuits, and no corresponding description will be provided since they are well known to a person skilled in the art.

According to the present invention, the problem of worsening the margins because of loss of the wall charges is eliminated since the addressing is not influenced by the wall charges formed in the reset period. The contrast ratio is improved since the amount of discharges during the reset period is reduced in the discharge cell which emits no light. Also, the maximum voltage applied to the PDP is reduced.

In addition, by applying a predetermined waveform during the sustain period, the positive wall charges which can exist in the scan electrode of the cell which is not selected during the address period are converted to the negative wall charges, and resetting is performed in the next reset period, and accordingly, the next addressing is performed well.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A method for driving a plasma display panel having a plurality of first electrodes and second electrodes respectively formed in parallel on a first substrate, and a plurality of third electrodes which cross the first electrodes and second electrodes and are formed on a second substrate, wherein a discharge cell is formed by an adjacent first electrode and second electrode, and a third electrode, and respective driving circuits for the first electrodes, second electrodes and third electrodes, the field being divided into a plurality of subfields and then driven, each subfield including a reset period, an address period, and a sustain period, and all the subfields respectively configure at least one field, comprising:
applying a ramp voltage which gradually falls from a first voltage to a second voltage to the first electrode, during the reset period;
respectively applying a third voltage and a fourth voltage to the first electrode and the third electrode of a discharge cell to be selected from among the discharge cells, during the address period; and
alternately applying a fifth voltage to the first electrode and to the second electrode, and applying a sixth voltage which has a gradually rising interval to the first electrode in at least one of intervals for applying the fifth voltage to the second electrode after applying the fifth voltage to the first electrode, during the sustain period.

2. A method for driving a plasma display panel having a plurality of first electrodes and second electrodes respectively formed in parallel on a first substrate, and a plurality of third electrodes which cross the first and second electrodes and are formed on a second substrate, wherein a discharge cell is formed by an adjacent first electrode and second electrode, and a third electrode, and respective driving circuits for the first electrodes, second electrodes and third electrodes, the field being divided into a plurality of subfields and then driven, each subfield including a reset period, an address period, and a sustain period, and all the subfields respectively configure at least one field, comprising:
applying a ramp voltage which gradually falls from a first voltage to a second voltage to a first electrode, during the reset period;
respectively applying a third voltage and a fourth voltage to the first electrode and a third electrode of a discharge cell to be selected from among the discharge cells, during the address period; and
alternately applying a fifth voltage to the first electrode and to the second electrode, and applying at least one sixth voltage which rises from the fifth voltage instantly after applying the fifth voltage to the first electrode, during the sustain period.

3. The method of claim 1, wherein the sixth voltage is greater than the fifth voltage.

4. The method of claim 1, wherein positive wall charges provided on the first electrode of the cell which is not selected in the address period are converted into negative wall charges by applying the sixth voltage.

5. The method of claim 2, wherein the waveform which rises to the sixth voltage from the fifth voltage is a resistor-capacitor resonance waveform.

6. The method of claim 2, wherein the waveform which rises to the sixth voltage from the fifth voltage is a ramp waveform.

7. The method of claim 2, wherein the waveform which rises to the sixth voltage from the fifth voltage is a floating waveform for repeatedly performing floating after a constant voltage variation.

8. The method of claim 2, wherein the waveform which rises to the sixth voltage from the fifth voltage is a staircase waveform for repeatedly maintaining a voltage after a constant voltage variation.

9. The method of claim 2, wherein no further wall charges are formed in the discharge cell during the reset period.

10. A method for driving a plasma display panel having a plurality of first electrodes and second electrodes respectively formed in parallel on a first substrate, and a plurality of third electrodes which cross the first electrodes and the second electrodes and are formed on a second substrate, wherein a discharge cell is formed by an adjacent first electrode and a second electrode, and a third electrode, comprising:
during the sustain period,
alternately applying a first voltage to a first electrode and a second electrode, and applying a second voltage which gradually rises to the first electrode in at least one of intervals for applying the first voltage to the second electrode after applying the first voltage to the first electrode; and
converting the positive wall charges provided on the first electrode of the cell which is not selected in the address period for selecting a cell to be selected into negative wall charges by applying the second voltage.

11. A method for driving a plasma display panel having a plurality of first electrodes and second electrodes respectively formed in parallel on a first substrate, and a plurality of third electrodes which cross the first electrodes and the second electrodes and are formed on a second substrate, wherein a discharge cell is formed by an adjacent first electrode and second electrode, and a third electrode, comprising:
during the sustain period,
alternately applying a first voltage to the first electrode and the second electrode, and applying at least one second voltage which rises from the first voltage instantly after applying the first voltage to the first electrode; and
converting positive wall charges provided on the first electrode of the cell not selected in the address period for selecting a cell to be selected into negative wall charges by applying the second voltage.

12. The method of claim 10, wherein the second voltage is greater than the first voltage.

13. The method of claim 11, wherein the waveform which rises to the second voltage from the first voltage is a resistor-capacitor resonance waveform.

14. The method of claim 11, wherein the waveform which rises to the second voltage from the first voltage is a ramp waveform.

15. The method of claim 11, wherein the waveform which rises to the second voltage from the first voltage is a floating waveform for repeatedly performing floating after a constant voltage variation.

16. The method of claim 11, wherein the waveform which rises to the second voltage from the first voltage is a staircase waveform for repeatedly maintaining a voltage after a constant voltage variation.

17. A plasma display comprising:
a first substrate;
a plurality of first electrodes and second electrodes facing the first substrate with a gap between respective pairs of first electrodes and second electrodes;
a second substrate;
a plurality of third electrodes crossing the first electrodes and the second electrodes and being formed on the second substrate; and
a driving circuit for applying a driving voltage to a first electrode, a second electrode and a third electrode to discharge a discharge cell formed by an adjacent first electrode, second electrode, and a third electrode, wherein:
the driving circuit alternately applies a first voltage to the first electrode and the second electrode, and applies a second voltage in at least one of intervals for applying the first voltage to the second electrode after applying the first voltage to the first electrode during a sustain period, the second voltage being greater than the first voltage to convert positive wall charges provided on the first electrode of a cell not selected in an address period for selecting a cell to be discharged into negative wall charges.
